(19) United States
(12) Patent Application Publication
(10) Pub. No.: US 2007/0055639 A1
(43) Pub. Date: Mar. 8, 2007

(54) Method and system for printing self-mailer including color-postal form

(76) Inventors: Lee Garvey, Arlington, VA (US); Rajesh Laddha, South Riding, VA (US); Richard Chlebos, Toano, VA (US)

Correspondence Address: WINSTON & STRAWN LLP;PATENT DEPARTMENT, 1700 K STREET, N.W., WASHINGTON, DC, 20006, US

(21) Appl. No.: 11/510,910

(22) Filed: Aug. 28, 2006

Related U.S. Application Data
(60) Provisional application No. 60/711,507, filed on Aug. 26, 2005.

(51) Int. Cl. G06F 17/00

(52) U.S. Cl. 705/410

(57) ABSTRACT

A method, for forming a tracked self-mailer is provided. The method comprises: generating a print image comprising a shipping label, a color-postal-form, and a document, wherein the shipping label comprises a delivery address, a return address, and a tracking number; printing the print image on a sheet of paper comprising a first face and an opposite second face, such that the shipping label and the color-postal-form are printed on the first face and the document is printed on at least a portion of the second face, wherein the print image is printed on the first face and the second face, substantially contemporaneously; folding the sheet of paper, such that the first face is readable and forms an envelope comprising three non-closed edges, an address panel, and a non-address panel, wherein the shipping label is wholly displayed in the address panel; and sealing the three non-closed edges, such that the second face of the sheet of paper is unreadable without manipulating the seal. The method can further comprise: providing at least one processor interfacing a network; receiving through the network an electronic version of the document; receiving through the network one or more options for printing the document; receiving through the network the delivery address; and receiving through the network the return address. A system and computer program teaching the same are provided.

### CROSS-REFERENCE TO OTHER APPLICATIONS

The present application claims benefit from U.S. Provisional Application No. 60/711,507, filed Aug. 26, 2005, the entire content of which is hereby incorporated herein by reference thereto.

### FIELD OF THE INVENTION

The present invention relates to systems and methods for automated production, transmission, and delivery of documents.

### BACKGROUND

While mailers have become a very common type of business form, some mailers are ineffective or obsolete when used with current postal service technology or with restrictions concerning the placement of the address information on mailers. Likewise, thickness restrictions relating to the capabilities of printers reduce the effectiveness of certain mailers. U.S. Patent Application Publication No. 2004/0008368 A1, published Jan. 15, 2004 teaches a method and system are for delivery of a printed document, and its entire content is hereby incorporated herein by reference thereto. Of particular concern in the present application is a mailer and method for using the same for CERTIFIED MAIL and PRIORITY MAIL.

It is therefore desirable to facilitate generating and sending documents by customers through increased use of automation. This may be achieved by eliminating manual processing stages, which reduces inconvenience and aggregate cost of producing a small volume or short-run mailing. There exists a need for automated production of certified mailings by eliminating manual processing stages, to reduce certified mailing production costs by for example taking advantage of new printing technologies, and increase consumer convenience. There exists a further need for a convenient way for consumers to create and send certified mailings from a home or office computer. There also exists a need for certified mailings that are mail-merged and reduce postage charges for customers by for example, standardizing postal addresses, sorting the mailings, and other lower postal cost solutions to customers sending small mailings, by coalescing several small mailings into a large mailing to take advantage of cheaper postal rates.

### SUMMARY

According to various embodiments, a method for forming a tracked self-mailer is provided. In a preferred embodiment, the method includes:

generating a print image comprising a shipping label, a color-postal-form, and a document, wherein the shipping label comprises a delivery address, a return address, and a tracking number;

printing the print image on a sheet of paper comprising a first face and an opposite second face, such that the shipping label and the color-postal-form are printed on the first face and the document is printed on at least a portion of the second face, wherein the print image is printed on the first face and the second face, substantially contemporaneously;

folding the sheet of paper, such that the first face is readable and forms an envelope comprising three non-closed edges, an address panel, and a non-address panel, wherein the shipping label is wholly displayed in the address panel; and

sealing the three non-closed edges, such that the second face of the sheet of paper is unreadable without manipulating the seal.

In various embodiments, the printing can comprise printing a postage indicia on the first face. The printing can comprise printing the color-postal-form partially on the address panel and partially on the non-address panel. The printing further can comprise printing a taggant on the address panel. The print image can be printed on the first face and the second face simultaneously.

According to various embodiments, the envelope can comprise a length of from about 8 inches to about 11.5 inches, a height of from about 4 inches to about 6 inches, and a thickness of less than about 0.25 inch. When a 11 inch by 17 inch sheet of paper is used, the envelope can comprise a length of about 11 inches and a width of about 8.6 inches.

In various embodiments, the folding can comprise aligning the partially printed color-postal-form on the address panel with the partially printed color-postal-form on the non-address panel. The folding can comprise two or more folds and the printing comprises printing the document on at least a portion of the first face.

In various embodiments, the color-postal-form can comprise a PRIORITY MAIL indicia in red and blue colors. The color-postal-form can comprise a CERTIFIED MAIL indicia in a green color. The color-postal-form can comprise a return receipt and the method can comprise weakening the sheet of paper along a periphery of the return receipt, such that the return receipt can be torn from the sheet of paper. The color-postal-form can comprise a CERTIFIED MAIL indicia in a green color.

In some embodiments, the method can comprise providing a 8.5 inch by 14 inch sheet of paper, the printing can comprise printing a postage indicia on the first face, and printing the color-postal-form partially on the address panel and partially on the non-address panel, the folding can comprise three parallel latitudinal folds, such that the non-address panel comprises an end of the sheet of paper, and the sealing can comprise applying at least one tab to each of the three non-closed edges.

The method can comprise providing a 11 inch by 17 inch sheet of paper, the printing can comprise printing a postage indicia on the first face, and printing the color-postal-form partially on the address panel and partially on the non-address panel, the folding can comprise one latitudinal fold, and the sealing can comprise applying at least one tab to each of the three non-closed edges.

The method can include providing at least one processor interfacing a network; receiving through the network an electronic version of the document; receiving through the network one or more options for printing the document; receiving through the network the delivery address; and receiving through the network the return address. The document can conform to a predetermined file format selected from one or more of MS WORD and Portable Document Format (PDF).

The one or more printing options preferably include one or more finishing instructions, selected from one or more of folding, binding, stapling, tabbing, adhesive, single-sided printing, double-sided printing, full color printing, limited color printing, and black & white printing. The one or more printing options can comprise a service class selected from one or more of First-Class service and Priority service. The one or more printing options can comprise a service class option selected from one or more of CERTIFIED MAIL, CERTIFIED MAIL with return receipt, and CERTIFIED MAIL with electronic return receipt. The one or more printing options comprises a paper size, selected from 8.5 inch by 11 inch paper, 8.5 inch by 13 inch paper, 8.5 inch by 14 inch paper, 8.5 inch by 14.5 inch paper, 11 inch by 17 inch paper, A4 size paper, and A5 size paper.

According to various embodiments, the method can comprise merging the document with the delivery address. The method can comprise receiving through the network, information for customizing the document, and merging the document with the information to create a customized document. The method can comprise standardizing the delivery address to conform with a predetermined address format. The method can comprise verifying the delivery address with a database to determine if an addressee corresponding to the delivery address has changed his physical delivery address, and updating the delivery address when it is determined that the physical delivery address has changed. The method can comprise: estimating a fee for printing the document, estimating a fee for delivering the printed document to the delivery address, and accepting payment based on the estimated fee for printing the document and the estimated fee for delivering the printed document. The method can comprise reporting to a user the tracking number of the mail piece. The method can comprise electronically tracking a delivery of the envelope.

A method for forming a tracked self-mailer is provided, preferably including:

pre-printing a color postal form on a sheet of paper;

generating a print image comprising a shipping label, and a document, wherein the shipping label comprises a delivery address, a return address, and a tracking number;

printing the print image on the sheet of paper comprising a first face and an opposite second face, such that the shipping label and the color-postal-form are printed on the first face and the document is printed on at least a portion of the second face;

folding the sheet of paper, such that the first face is readable and forms an envelope comprising three non-closed edges, an address panel, and a non-address panel, wherein the shipping label is wholly displayed in the address panel;

sealing the three non-closed edges, such that the second face of the sheet of paper is unreadable without manipulating the seal; and

electronically tracking a delivery of the envelope.

Also, a system is provided for forming a tracked self-mailer using at least processor interfacing a network is provided. The system preferably includes:

means for receiving through the network, a document, a delivery address, a return address, and one or more options for printing;

means for generating a tracking number;

means for generating a print image comprising a shipping label, a color-postal-form, and the document, wherein the shipping label comprises the delivery address, the return address, and the tracking number;

a printing device adapted to print the print image on a sheet of paper comprising a first face and an opposite second face, such that the shipping label and the color-postal-form are printed on the first face and the document is printed on at least a portion of the second face, wherein the print image is printed on the first face and the second face, substantially contemporaneously;

a folding device that folds the sheet of paper, such that the first face is readable and forms an envelope comprising three non-closed edges, an address panel, and a non-address panel, wherein the shipping label is wholly displayed in the address panel; and

a sealing device that seals the three non-closed edges, such that the second face of the sheet of paper is unreadable without manipulating the seal.

The printing device can print postage indicia on the first face. The printing device can print the color-postal-form partially on the address panel and partially on the non-address panel, and the folding device can align the partially printed color-postal-form on the address panel with the partially printed color-postal-form on the non-address panel. The system can comprise a taggant printer that prints a taggant on the address panel.

According to various embodiments, the color-postal-form can comprise a PRIORITY MAIL indicia in red and blue colors. In some embodiments, the color-postal-form can comprise a CERTIFIED MAIL indicia in a green color. In some embodiments, the color-postal-form can comprise a return receipt and the system can comprise a perforating device capable of perforating the sheet of paper along a periphery of the return receipt, such that the return receipt can be torn from the sheet of paper. The color-postal-form can comprise a CERTIFIED MAIL indicia in a green color.

According to various embodiments, a computer program product, comprising a computer readable medium having computer program code embodied in said medium, for delivery of a printed document using at least one processor interfacing a network is provided. The program code can include:

code for receiving through the network, a document, a delivery address, a return address, and one or more options for printing;

code for generating a tracking number;

code for generating a print image comprising a shipping label, a color-postal-form, and the document, wherein the shipping label comprises the delivery address, the return address, and the tracking number; and

code for printing the print image on a sheet of paper comprising a first face and an opposite second face, such that the shipping label and the color-postal-form are printed on the first face and the document is printed on at least a portion of the second face, wherein the print image is printed on the first face and the second face, substantially contemporaneously,

wherein the sheet of paper is folded, such that the first face is readable and forms an envelope comprising three non-closed edges, an address panel, and a non-address panel, wherein the shipping label is wholly displayed in the address panel, and the sheet of paper is sealed along the three non-closed edges, such that the second face of the sheet of paper is unreadable without manipulating the seal.

It is to be understood that both the foregoing general description and the following detailed description are exemplary and explanatory only and are intended to provide a further explanation of the present teachings, as claimed.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram of an exemplary model for communication between a customer and a service provider in which methods and systems consistent with the present invention may be implemented;

FIGS. 2A and 2B are flow charts of an exemplary technique for sending a document from the customer to an addressee;

FIG. 3 is an exemplary model for generating tracked self-mailers of the present teachings;

FIGS. 4A and 4B are plan views of an exemplary certified self-mailer, with a return receipt;

FIG. 4C is an exemplary perspective view of a certified self-mailer, with a return receipt;

FIG. 5A is a plan view of a certified self-mailer;

FIG. 5B is a perspective view of a certified self-mailer;

FIG. 6A is a top view of an exemplary priority self-mailer;

FIG. 6B is a perspective view of an exemplary priority self-mailer;

FIG. 7 is a an exemplary graphical user interface for displaying a second face of a sample certified self-mailer with a return-receipt card prior to a delivery address having been specified;

FIG. 8 is an exemplary graphical user interface for displaying a second face of a certified self-mailer with a return receipt after a delivery address has been specified; and

FIG. 9 is an exemplary graphical user interface for displaying a first face of a certified self-mailer with a return receipt after a s address and a delivery address have been specified.

### DESCRIPTION OF VARIOUS EMBODIMENTS

Traditionally, customers generate mailings by producing documents in physical form for sending the physical documents to a service provider (SP), such as the United States Postal Service (USPS™), Federal Express (FEDEX™), or United Parcel Service (UPS™). The SP must sort each physical document by delivery address, transport each physical document to a SP hub located near the delivery address, and deliver each document to the designated delivery address.

The traditional scheme for producing and sending documents is inconvenient and inefficient for small volume or short-run mailings. For example, consider a customer who needs to print and send a few thousand brochures. Initially, the customer may contract with a printer to print, fold and staple each brochure. Then the printer prepares sample brochures, which the customer reviews before beginning a production run. Typically, a customer may inspect several samples to determine whether the printer provides an acceptable quality of service before authorizing the printer to begin production.

Next, the customer addresses each brochure with a delivery address of an intended recipient selected from an address list. Each brochure usually must be addressed according to a specific predetermined format. For example, when the USPS™ is selected as the SP, a format specified by postal regulations is required to qualify for discounted service rates. The customer can create and maintain his own mailing list. However, maintaining a list of several thousand addresses in the required format for discounted service rates may be inconvenient and inefficient for many customers. The customer may also find that addressing a few thousand brochures that have been folded and stapled requires significant manual effort. After the brochures have been addressed, the customer transports the brochures to the SP.

Finally, the SP accepts the brochures from the customer. First, the SP must examine each brochure to determine the intended delivery address. Second, the SP routes each brochure to a SP distribution site located near the delivery address. Third, each brochure must be delivered to the intended recipient. Each brochure that is sent must be handled several times before delivery to the intended recipient. Thus, a significant fraction of the cost to produce and send a document may be attributed to physically transporting the document from place to place.

Traditional electronic mailing services, such as e-mail, offer a lower-cost alternative for distribution of documents, when the customer has an appropriate address for routing documents to the intended recipient. However, business mailings are often targeted to recipients based on their geographic location. The customer may be unable to determine an appropriate e-mail address corresponding to each street address. Also, many potential mail recipients do not have e-mail addresses. Consequently, traditional electronic mailing services do not provide an effective alternative to the traditional mailing scheme.

Reference will now be made in detail to the present exemplary embodiments of the invention, examples of which are illustrated in the accompanying drawings. Wherever possible, the same reference numbers will be used throughout the drawings to refer to the same or like parts.

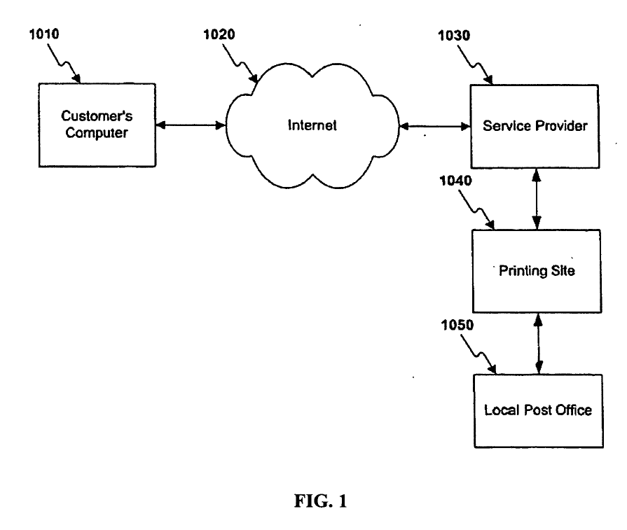

FIG. 1 shows a general block diagram of a customer and service provider communication model in which methods and systems consistent with the present invention may be implemented. Although the system set forth herein is described with respect to the USPS™, the system and methods described are not limited to the USPS™ but may be used with other service providers (SP) such as Federal Express (FEDEX™), or United Parcel Service (UPS™). A customer may use a processor 1010, such as a personal computer, to transmit a document to a service provider 1030 through a network 1020, such as the Internet. SP 1030 may distribute the document to a printing site 1040. Then the printing site 1040 may print the document and provide the printed document to a letter carrier 1050, such as a local post office, to physically transport the printed document to a physical delivery address.

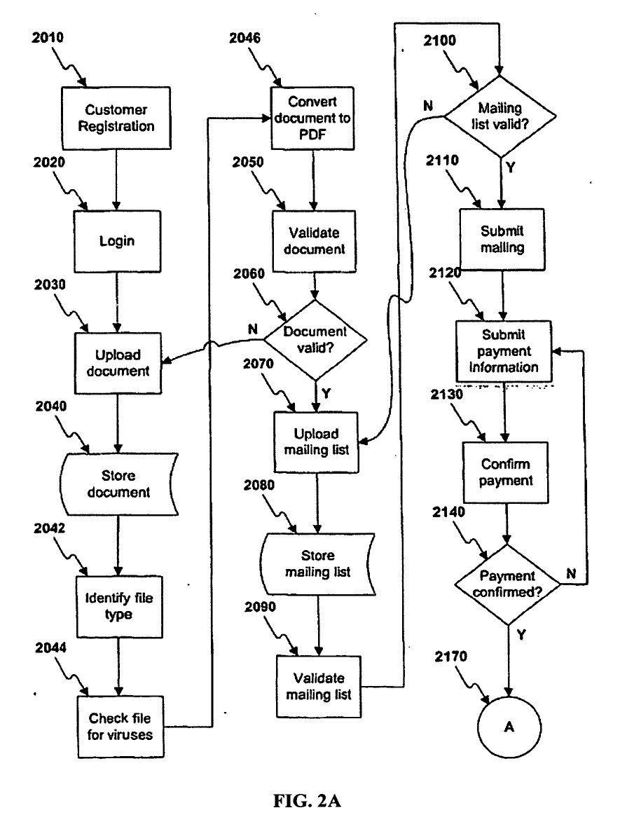

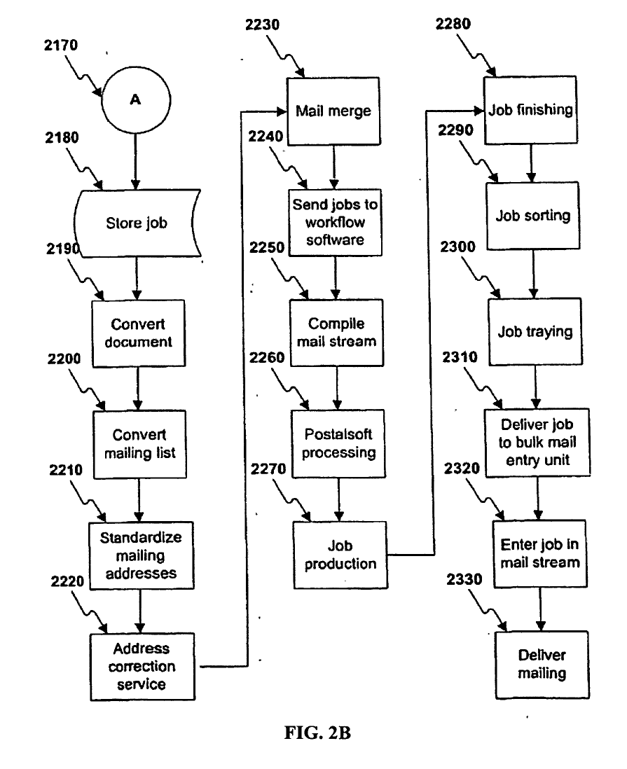

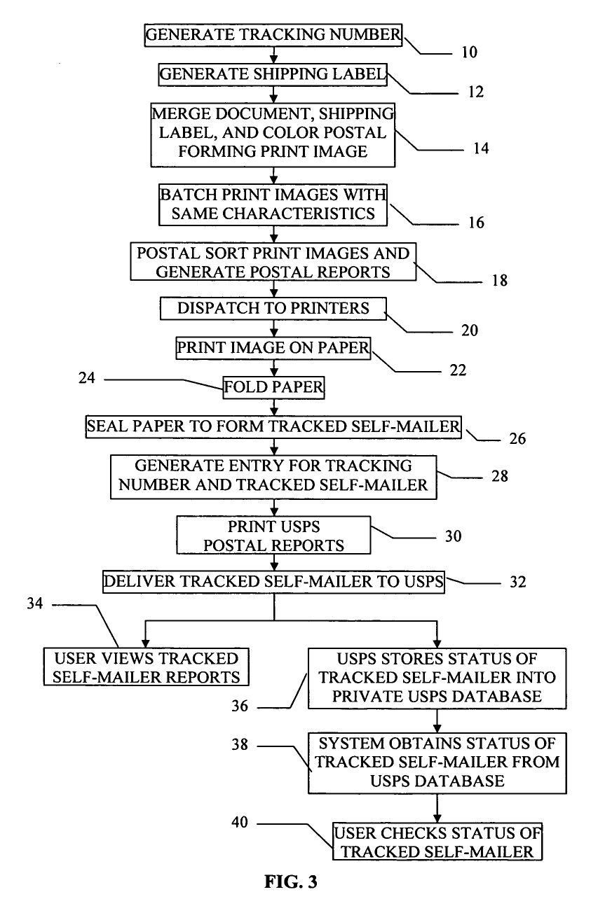

FIG. 2A shows an exemplary flow chart that illustrates a technique for sending the document from the customer to an addressee. First, the customer may communicate with the SP 1030 (FIG. 1) using a browser program on the personal computer 1010 to access the SP 1030 through the network 1020. For example, the customer may use the NAVIGATOR™ program developed by NETSCAPE™, or the INTERNET EXPLORER™ program developed by MICROSOFT™ to access a graphical user interface, such as the one shown in FIG. 3, provided by the SP 1030.

Referring back to FIG. 2A, after the customer is authenticated by the SP 1030, the customer may provide an electronic version of a document to the SP 1030 (stage 2030). The customer may either create a document on-line, such as by typing information into a text box provided by the SP 1030, or the customer may upload the document in a recognized format. For example, the customer may upload the document in the format recognized by word processing software such as MS WORD™ or WORDPERFECT™; or by desktop publishing software such as PAGEMAKER™, VENTURA™ or QUARK™. Alternatively, the document may be uploaded in a platform-independent format, such as PostScript™ or the Portable Document Format (PDF) developed by ADOBE™. Systems consistent with the present invention may include new document formats as desired.

Next, the SP 1030 may store the electronic version of the document to facilitate additional processing (stage 2040). For example, the SP 1030 may store the provided document for a period of time, such as 60 days. The customer may also manage documents stored by the SP 1030. For example, the customer may selectively delete documents stored by the SP 1030. Then the SP 1030 may determine the file types of the document and the mailing list (stage 2042). If the document has characteristics that may be harmful to the mailing online system, then the document may be filtered out. For example, the SP 1030 may reject the document and advise the customer if the document incorporates unsupported features of an otherwise recognized document format. The SP 1030 may also examine the document to determine whether it should be merged with information from the mailing list, as a mail merge file. After the file type is determined, the SP 1030 may examine the file for viruses (stage 2044). For example, the SP 1030 may examine the file to determine if the document contains a MS-WORD™ macro virus. The SP 1030 may reject the document and advise the customer if the SP 1030 determines that the document contains a virus.

Next, the document file may be converted into an intermediate format, such as PDF (stage 2046). For example, a WORDPERFECT™ document file may be converted into a PDF document for better compatibility. After the document is converted, the customer may validate the document (stage 2050). For example, the customer may proof the converted document using the browser on the personal computer to view the converted document and verify that the document was converted properly. If the document is not valid (stage 2060), then the customer may upload another document (stage 2030).

The customer may then provide an address list to the SP 1030 (stage 2070). The customer may either create an address list, such as by typing information into a provided text box, or may upload the mailing list in a recognized format. Thus, the customer may assemble the mailing list by downloading the addresses and data from existing commercial databases, then upload the mailing list to the SP 1030. For example, the customer may upload the mailing list in MS EXCEL™, MS ACCESS™, MS WORD™ table, or ASCII delimited text format. Systems consistent with the present invention may include additional mailing list formats as desired.

Next, the SP 1030 may store the mailing list locally to facilitate additional processing (stage 2080). For example, the SP 1030 may store the mailing list for a predetermined period of time, such as 60 days. After the mailing list is stored, the SP 1030 may validate that the mailing list conforms to the specified predetermined format (stage 2090). For example, the SP 1030 may verify that an address list designated as a MS EXCEL™ document actually conforms to the MS EXCEL™ specification. If the mailing list is not valid (stage 2100), then the customer may upload another mailing list (stage 2070).

The SP 1030 may also validate each physical delivery address in the list. For example, the SP 1030 may verify that a street address is within a valid range of addresses and that a ZIP code corresponds to a designated city and generate a report identifying addresses that cannot be matched with a database. For example, the SP 1030 may attempt to match addresses with the USPS™ Address Management System database. The customer may either purge the identified addresses from the list, or may send the document to the identified addresses at a non-discounted service rate.

Then the SP 1030 may estimate a fee for sending each document to each address in the mailing list. For example, the SP 1030 may estimate a fee for delivery of each document based on whether the document will be sent at a First-Class service rate, a Standard service rate, or a Non-Profit service rate. The SP 1030 may also consider other factors when estimating the fee for delivery of each document. For example, the SP 1030 may consider location of the printing site 1040 relative to each address in the mailing list, the depth of sorting possible for the documents to be delivered, and whether the type of document to be sent, such as a postcard, may qualify for a reduced service rate. If the customer accepts the mailing list, the document is submitted for mailing (stage 2110). The customer may select from predetermined printing and finishing specifications, select a desired service class, and select the type of documents being sent.

The SP 1030 may also estimate a fee for printing each document. For example, the SP 1030 may select a printing site 1040 from one or more printing sites, based on proximity to the delivery address of the document; production capacity of the printing site for the type of document selected by the customer, such as a booklet; whether the printing site 1040 is presently operational; and a fee for printing the type of document selected by the customer at the printing site 1040. Printing fees may also vary according to the number of printing colors selected by the customer. For example, a fee for printing a document in black & white may be less than a fee for printing the document in color, and a fee for printing the document with a limited number of colors, such as a highlight color, may be less than a fee for full color printing, such as for a photo-realistic image. The printing fee may also vary according to the type of paper selected by the customer. For example, the customer may select off-white 28# paper, white 24# paper, yellow 24# paper, or white 80# postcard stock. The printing fee may further vary according to the paper size. For example, the customer may select to print the document on 8.5 inch by 11 inch paper, 8.5 inch by 14 inch paper, 11 inch by 17 inch paper, A4 size paper, or A5 size paper. The SP 1030 may then estimate fees for printing and delivery of the documents to the customer.

For example, the mailing list may include both domestic addresses within the United States and international addresses. The SP 1030 may determine which printing sites can produce the type of document selected by the customer based on printing and finishing services offered at each printing site and the printing site's capacity to produce documents of the selected type. The SP 1030 may then estimate fees for printing the document at each available site, and estimate fees for sending each document from each site to the corresponding delivery address. The SP 1030 may combine the fees for printing and sending each document to provide the customer with a report detailing the shipping cost, printing, and production fees. Then the customer may approve the transaction and provide payment information, such as a credit card number, prepaid account, or other approved payment method (stage 2120). The SP 1030 may confirm the payment by validating the payment information (stage 2130), such as by billing the credit card for the specified fees. If the payment is not confirmed (stage 2140), then the customer may provide alternative payment information (stage 2120). The mailing online process flow of FIG. 2A is continued in FIG. 2B (stage 2170). After the payment is confirmed, the job may be stored for processing (stage 2180). The document may be converted into another intermediate format to facilitate merging the document with the mailing list (stage 2190). Similarly, the mailing list may be converted into an intermediate format to facilitate merging the mailing list with the document (stage 2200). For example, a MS-ACCESS™ mailing list may be converted into an ASCII delimited text file for improved compatibility.

After the mailing list is converted, the delivery addresses may be standardized (stage 2210). For example, a “standardized” address may conform to an address format specified in USPS Publication 40, Address Information Systems: Products and Services,(PUB 40), which is incorporated herein by reference in its entirety. PUB 40 defines a standardized address as having certain characteristics, such as, the bottom line should include only the city name, state, and correct ZIP CODE™ or ZIP+4 code for the delivery address; the next line up from the bottom should include the delivery address; and the next line up from the bottom should identify the intended recipient. Additional “standardized” address are specified in USPS Publication 28, Postal Addressing Standards (PUB 28), which is incorporated herein by reference in its entirety. PUB 28 provides specifications for physical delivery addressing standards and business addressing standards including, for example, guidelines for address formatting, two-letter state and possession abbreviations, street abbreviations, unusual addressing situations, alphanumeric and/or fractional coding. PUB 28 also provides abbreviations for county, state, and local highways; business words; and Spanish-language addresses.

Standardizing a delivery address may convert an incomplete delivery address into a complete delivery address. For example, if the street name in the delivery address is spelled incorrectly, the street name may be corrected. For another example, if the street name is missing a directional signal, such as “N” for north, “S” for south, “E” for east, or “W” for west, then the missing directional signal may be added. For yet another example, if part of the street name is missing, such as “road,” “street,” “avenue,” or “boulevard,” then the missing information may be added. Thus, an incomplete address may be converted into a correct and complete delivery address before the document is sent.

After the addresses are standardized, each address may be updated by an address correction service (stage 2220). For example, addresses may be updated by verifying each address in the mailing list using the USPS's FASTFORWARD™ service, NCOALink (National Change of Address Linking) service, or other services known in the art, which include a National Change of Address database. If an addressee has moved, then the address in the mailing list may be replaced with the addressee's new address.

Next, the document may be merged with information from the mailing list (stage 2230). For example, the MS-WORD™-mail merge tool or the WORDPERFECT™ mail merge tool may be used to merge the document with each record in the mailing list. The mailing list may include one or more delivery addresses, as well as additional information for customizing each document. For example, the customer may send itemized invoices to each address in the mailing list. The additional information may include a description of services for each recipient, a fee associated with the services, and an account balance. The mail merge tool may merge the additional information may be merged into the document to customize each mail piece for the intended recipient. The additional information may also include job data, such as printing and finishing instructions. The customer may also indicate that an enclosure, such as, for example, a reply envelope or a personalized coupon, should be sent to some delivery addresses.

Then the merged documents and job data may be organized for routing to one or more printing sites, such as, for example, by using workflow software (stage 2240). The “jobs”, comprising the merged document and job data, may be compiled into a mailstream and transmitted to the one or more printing sites (stage 2250). For example, a job may be transmitted to a first printing site 1040. If the first printing site 1040 becomes unable to process the job, for example, due to equipment failure, then the first printing site 1040 may inform the SP 1030 and the SP 1030 may transmit the job to a second printing site (not shown). Otherwise, the first printing site 1040 may process the job and indicate to the SP 1030 that the job has been printed. The SP 1030 may wait for a predetermined period of time, for example, 24 hours, to receive the indication from the first printing site 1040 that the job has been printed. If the SP 1030 does not receive the indication from the first printing site 1040 within the predetermined period of time, then the SP 1030 may transmit the job to the second printing site to be printed. Thus, if the SP 1030 becomes unable to communicate with the first printing site 1040, then the job may be printed by the second printing site.

At each printing site, each “job” may be pre-sorted before printing to facilitate delivery of the mail pieces according to mail carrier routes (stage 2260). For example, POSTALSOFt™ software, manufactured by Addressing Systems and Products, Inc., may sort each job by ZIP+4 code before printing. Then the jobs may be printed (stage 2270) to produce mail pieces, and each mail piece may be finished (stage 2280). For example, each merged document may be stapled, folded, and inserted in an envelope, according to the customers selections. The finished mail pieces may be sorted (stage 2290), placed in trays (stage 2300), and delivered to a bulk mail entry unit (BMEU) (stage 2310). For example, the mail pieces may be organized into ascending numeric sequential order, marked with a unique identifier on each piece, such as a delivery bar code, placed into a postal tray, and transported to a specialized facility for accepting mail pieces that are presorted according to standards specified in the USPS Domestic Mail Manual. Then each mail piece may be distributed for letter carrier delivery (stage 2320) and delivered to the addressee (stage 2330).

FIG. 3 shows an exemplary flowchart that illustrates a method for creating a tracked self-mailer. A print image can be used to send a document from a customer to an addressee. Once a user has selected a mailing that requires a tracking number and has posted payment for it, the service provider can generate a tracking number for a mail piece. A tracking number can be formatted differently for different types of mailings. For example, for a CERTIFIED MAIL piece, the tracking number can comprise twenty digits, a composite number comprising a SP's Dunn and Bradstreet Corporate identifier number, an incrementing counter, and a check sum. A tracking number for a PRIORITY MAIL piece can be generated similarly or using a different scheme, as provided in the United States Domestic Mail Manual. Once the SP has generated the tracking number (stage 10), the SP can generate a shipping label (stage 12). The shipping label can comprise the tracking number, a tracking bar code that can be a conversion of the tracking number into bar code font, a delivery address, and a return address. The document selected by the user can then be merged with the shipping label, and a specified color-postal-form to generate or form a print image (stage 14). The service provider can optionally batch print images with same characteristics up to one large print stream (stage 16). If the print images are batched, an event, for example, a cut off time, a maximum batch size, or a print load, can be used to trigger a dispatch of the batch to a printer or a print site. The dispatch can perform, for example, a postal sort on the print images and their corresponding addresses to generate a print stream in compliance with the postal sort order in the batch (stage 18). The postal sort can generate any desired U.S. Postal reports in stage 24. Either individual print images can be singly printed on paper or the batch of print images can be printed on a plurality of papers in stage 16. Paper or papers can be folded in stage 18 to form folded sheets of paper such that an addressing panel of the sheet of paper is outside or readable without unfolding the paper. The folded paper can then be sealed to form a tracked self-mailer in stage 20.

According to various embodiments, an entry for the tracked self-mailer can optionally be stored in a database in stage 22. The entry can comprise, for example, the tracking number, the delivery address, the return address, the print image, an electronic version of a signature, a delivery timestamp, or an expected delivery timestamp. The tracked self-mailer and/or any postal reports associated with the batch can then be delivered to the USPS for delivery to the delivery address in stage 26.

In various embodiments, once a tracked mail piece has been generated a user can view a status of tracked mail piece in stage 28. The USPS tracks delivery of tracked mail pieces and updates in an electronic database that comprises a signature and/or a delivery date for the tracked mail piece (stage 30). Once the postal service has entered such data into the database, the SP can obtain status of the tracked self-mailer from the USPS database in stage 32. This status can be matched to the tracked self-mailer and the status can be present in stage 34.

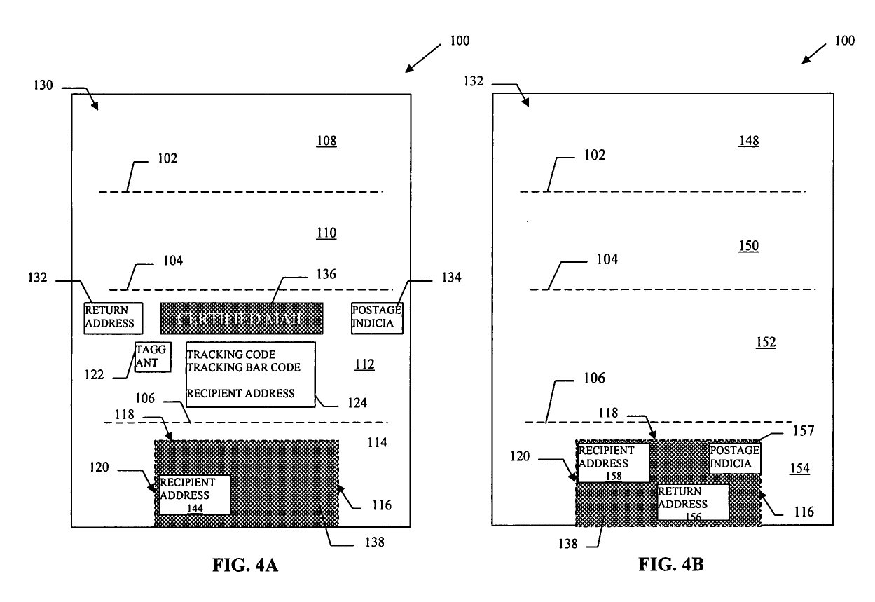

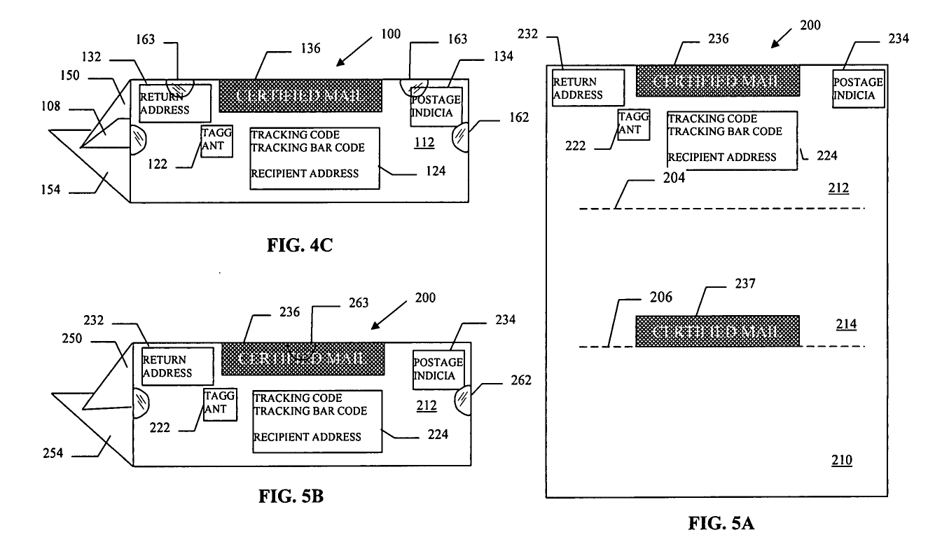

FIGS. 4A, 4B, and 4C, show an embodiment of a certified self-mailer 100 with a return receipt 138 defined therein. Self-mailer 100 can comprise a single sheet of paper comprising a first face 130 that can be divided into panels 108, 110, 112, and 114 on the first face 130. Panels 108, 110, 112, and 114 can be substantially equal. Fold lines 102, 104, 106 are depicted for illustration purposes. Fold lines 102, 104, 106 do not have to be pre-creased in self-mailer 100. Panel 112 can comprise an address panel. Panel 114 can comprise a non-address panel. Address panel 112 can comprise a postage indicia 134, a color-postal-form 136, a return address 132, a taggant 122, and a shipping label 124. Shipping label 124 can comprise a tracking code, a tracking bar code, and a delivery address. Non-address panel 114 can comprise a color-postal-form 138. Color-postal-form 138 can comprise a return receipt, for example, postal form PS Form 3811. Color-postal-form 138 can comprise a delivery address 120 on panel 114. Color-30 postal-form 138 can be weakened along its periphery. In some embodiments, color-postal-form 138 need only be weakened or perforated along three edges or sides, for example, perforation lines 116, 118, and 120 that can allow color-postal-form 138 to be torn, ripped, or removed from self-mailer 100 when desired.

According to various embodiments, second face of 132 self-mailer 100 can comprise panels 148, 150, 152, and 154. Panel 154 can comprise an opposite side or face of color-postal-form 138. On panel 154, color-postal-form 138 can comprise a delivery address 158 in the from position of an address format, a return address 156 in the to position of an address format, and a postal indicia 157 for postage. With this format color-postal-form 138 can form a return receipt. Once removed from self-mailer 100, color-postal-form 138 can be mailed back to the sender of self-mailer 100.

Panels 148, 150, and 150 can be utilized to print a document or a portion of the document thereupon. In some embodiments, panels 108 and 110 can be utilized to print a document or a portion of the document thereupon.

FIG. 4C illustrates an embodiment of how self-mailer 100 can be folded and sealed. Self-mailer 100 can be folded in an extended C-fold. Sealing tabs 162, 163 can be adhered to a periphery of address panel 112 and a periphery of non-address panel 114 to compartmentalize, enclose, or envelope panels 108, 110, 148, 150, 152, and 154 therein.

Sealing tabs 163 can be applied such that color-postal-form 138 is not sealed or affixed, in other words, left open. This opening can assist in easy removal of color-postal-form 138, when desired. Sealing tabs 163 can be positioned on the longer edge of self-mailer 100 such that they lie outside the length of color-postal-form 138. When disposed in such a manner, a postal carrier can remove the color-postal-form 138 allowing the perforations without breaking the seal of self-mailer 100. Self-mailer 100 can comprise a sheet of paper about 8.5 inches in width and about 14 inches in length.

FIGS. 5A and 5B, show an embodiment of a certified self-mailer 200. Self-mailer 200 can comprise a single sheet of paper comprising a first face 230 that can be divided into panels 210, 212, and 214 on the first face 230. Panels 210, 212, and 214 can be substantially equal. Fold lines 204, 206 are depicted for illustration purposes. Fold lines 204, 206 do not have to be pre-creased in self-mailer 200. In some embodiments, fold lines 204, 206 can be pre-creased in self-mailer 200. Panel 212 can comprise an address panel. Panel 214 can comprise a non-address panel. Address panel 212 can comprise a postage indicia 234, a color-postal-form 236, a return address 232, a taggant 222, and a shipping label 224. Shipping label 224 can comprise a tracking code, a tracking bar code, and a delivery address. Non-address panel 214 can comprise a color-postal-form 237.

According to various embodiments, an opposite second face (not shown) of self-mailer 200 can be utilized to print a document or a portion of the document thereupon. In some embodiments, panel 210 can be utilized to print a document or a portion of the document thereupon.

FIG. 5B illustrates an embodiment of how self-mailer 200 can be folded and sealed. Self-mailer 200 can be folded in a C-fold. Sealing tabs 262, 263 can be adhered to a periphery of address panel 212 and a periphery of non-address panel 214 to compartmentalize, enclose, or envelope panel, 210 and the opposite face of self-mailer 200 254 therein. Self-mailer 100 can comprise a sheet of paper about 8.5 inches in width and about 11 inches in length.

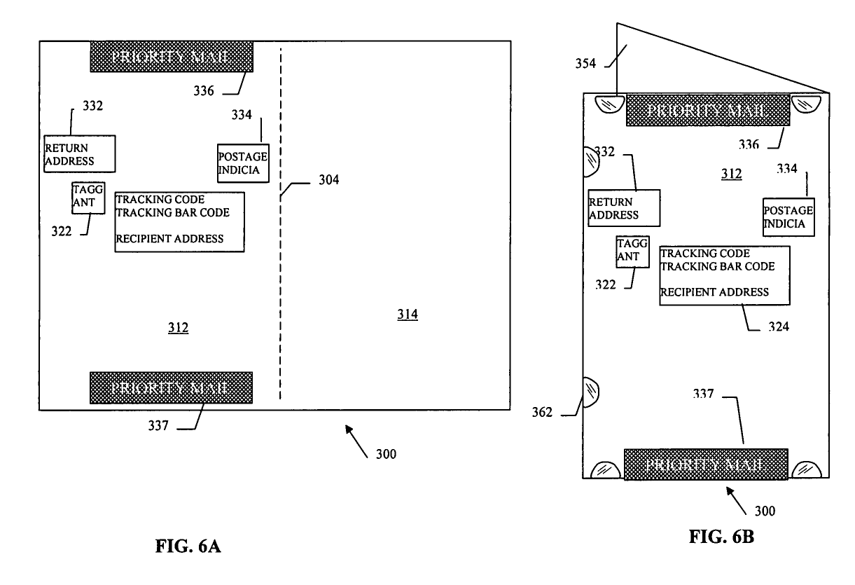

FIGS. 6A and 6B, show an embodiment of a certified self-mailer 300. Self-mailer 300 can comprise a single sheet of paper comprising a first face 330 that can be divided into panels 312 and 314 on the first face 330. Panels 312 and 314 can be substantially equal. A fold line 304 is depicted for illustration purposes. Fold line 304, does not have to be pre-creased in self-mailer 300. In some embodiments, fold line 304, can be pre-creased in self-mailer 300. Panel 312 can comprise an address panel. Panel 314 can comprise a non-address panel. Address panel 312 can comprise a postage indicia 334, a color-postal-form 336, a return address 332, a taggant 322, and a shipping label 324. Shipping label 324 can comprise a tracking code, a tracking bar code, and a delivery address. Non-address panel 314 can comprise a color-postal-form 337.

FIG. 6B illustrates an embodiment of how self-mailer 300 can be folded and sealed. Self-mailer 300 can be folded over. Sealing tabs 362, 363 can be adhered to a periphery of address panel 312 and a periphery of non-address panel 314 to compartmentalize, enclose, or envelope an opposite face 354 of self-mailer 300 354 therein. According to various embodiments, the opposite second face 354 of self-mailer 300 can be utilized to print a document or a portion of the document thereupon. Self-mailer 100 can comprise a sheet of paper about 11 inches in width and about 17 inches in length.

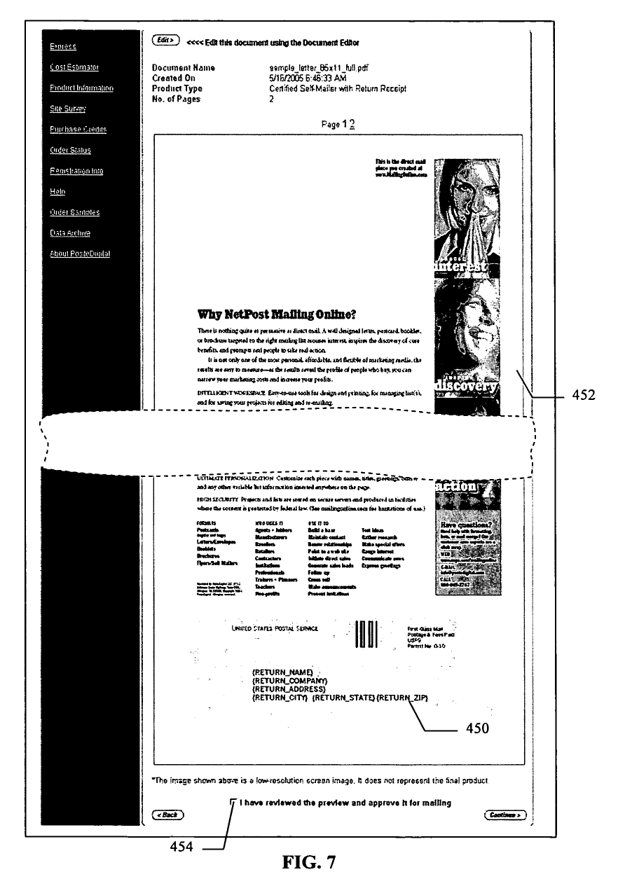

FIG. 7 is a an exemplary graphical user interface for displaying a second face of a sample certified self-mailer with a return-receipt card prior to a delivery address having been specified. A delivery address 450 comprising generic address fields is displayed in context with a document 452, for a user to preview and approve a mail piece composition prior to mailing by selecting a checkbox 454.

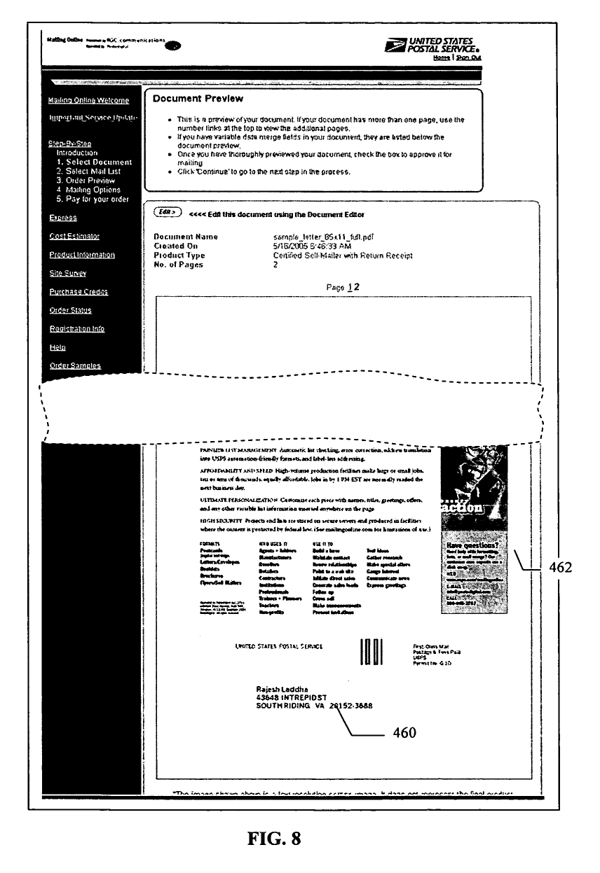

FIG. 8 is an exemplary graphical user interface for displaying a second face of a sample certified self-mailer with a return receipt after a delivery address has been specified. A delivery address 460 comprising user provided address fields is displayed in context with a document 462, for a user to preview and approve a mail piece composition prior to mailing by selecting a checkbox (not shown).

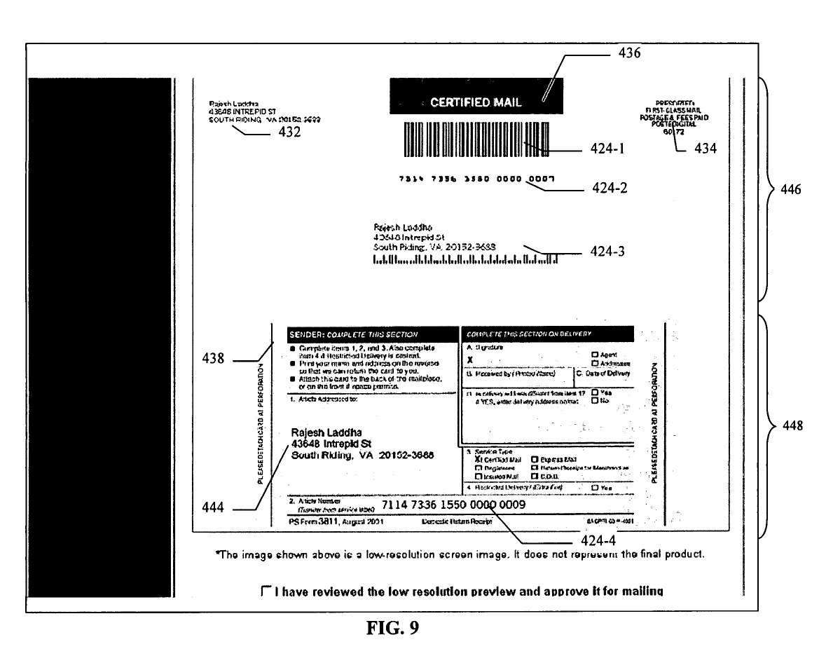

FIG. 9 is an exemplary graphical user interface for displaying a first face of a certified self-mailer with a return receipt after a return address and a delivery address have been specified. An address panel 446 can comprise a barcoded tracking number 424-1, a tracking number 424-2, a delivery address 424-3, a color-postal-form 436, a return address 432, and a postal indicia 434. A non-address panel 448 can comprise a color-postal-form 438. Within color-postal-form 438 a delivery address 444 and a tracking number 424-4. can be displayed.

According to various embodiments, substantially contemporaneously printing can occur in a single pass of a printer. The printer can print on a first face of a sheet and then print a second face of the sheet. In some embodiments, the printer can be capable of printing both faces of a sheet simultaneously. In other embodiments, the printer can be capable of printing on the first face of the sheet, flipping the sheet without any manual intervention, so as print on the second face of the sheet. In other embodiments, the flipping of the sheet can be done manually. According to various embodiments, the non-black-and-white-postal-form and shipping label can both be printed as co-occurring, coincidently, or at the same time. Print instructions or a print stream can be formatted to print the shipping label and the non-black-and-white-postal-form as a monolithic or integrated print operation.

A CERTIFIED MAIL piece can comprise a return receipt card. The return receipt card can comprise a postal form, for example, PS Form 3811—Domestic Return Receipt, as described in http://www.usps.com/cpim/ftp/pubs/pub109/109c5.html. PS Form 3811 can be from 3½ to 3⅔ inches high by about 7 to 7⅛ inches long overall; 3½ to 3⅔ inches by 5½ inches detached. Any form less than 3½ inches high or 5 inches in length is nonmailable. PS Form 3811 can be perforated along the entire 3½ inches to 3⅔ inches dimension, ¾ inch from the left and right edges.

CERTIFIED MAIL can be used with PRIORITY MAIL and first class mail, see for example, http://www.usps.com/send/waystosendmail/extraservices/certifiedmailservice.htm. CERTIFIED MAIL can provide Confirmation of Delivery with the following methods: Delivery Confirmation™—providing date and time of delivery or attempted delivery; and Signature Confirmation™—providing date and time of delivery or attempted delivery, the name of the person who signed for the item, plus signature proof of delivery upon request. USPS expects to provide an electronic Delivery Confirmation™ and Signature Confirmation™; these concepts are included in the present teachings. Electronic Return Receipt is presently available USPS for PRIORITY MAIL class. For each generated tracked color postal form, a consumer can retrieve an electronic Return Receipt from USPS when such service is purchased at the time of mailing with CERTIFIED MAIL™, Insured Mail, Collection on Delivery (COD), and Registered Mail™. In a preferred embodiment, the tracking numbers for the generated mail pieces are remembered, and at a later time, the electronic return receipt is retrieved or obtained via a computer, for example, by accessing a web-site that was used to originally send out CERTIFIED MAIL pieces.

An address panel can comprise a taggant. The taggant area can be a single area (minimum dimension 0.5 inch×0.5 inch; maximum dimension 0.7 inch×0.7 inch) located to the left of the barcode on the label section, approximately 11/16 inch from the bottom of the label. The taggant material preferably is Angstrom #6 Sub-micron Scanning Compound 17 percent concentration at a coat weight of 2 mils (0.002 inch), available from Angstrom Technologies of Erlanger, Ky.

An exemplary apparatus for implementing the present teachings can comprise for example: a printer, for example, a Xerox iGen3™ Digital Production Press available from Xerox Corporation; a folder, for example, an MBO T49 folder available from J.A.S. Graphics, Inc. of Indianapolis, Ind.; and a tabber or tabbing machine, for example, a Kirk-Rudy model 535 available from Peak Business Equipment, Inc. of Bridgeton, Mo. that can be used to apply pressure sensitive tabs, stamps, or labels. The MBO T49 can be equipped with a perforation or a scoring option.

According to various embodiments, the paper can comprise a 80 lb white cougar paper having a smooth opaque cover. The tabs can comprise generic clear, round tabs. The ink can comprise Xerox Toner. The taggant ink can be obtained from Angstrom Technologies, Kennedy Ink, rubber-based TR White 14% SC #27. The system can further comprise ripping software to translate a print image defined in a high level language or format, for example, Adobe Postscript™, Adobe PDF, PCL5c, PCL6XL, or TIFF, into a printer native language. The ripping software can comprise FreeFlow™ DocuSP available from Xerox Corporation.

In here a seal is a device or method for special closure of a mail piece, that reveals tampering, i.e., a closure for a package or container that must be broken when the package or container is opened and can therefore reveal tampering.

According to various embodiments, a color-postal-form is a postal form that can or must be printed in more colors than black and white. In various embodiments, color printing can comprise printing in two or more colors. Printing technologies can comprise a sub-system for printing with a black or a mono-color ink or toner, and a second system or sub-system for printing in a second color or color printing subsystem capable of printing in colors other than black. The white printing in black and white can be provided by printing on white paper.

Other embodiments of the present teachings will be apparent to those skilled in the art from consideration of the present specification and practice of the present teachings disclosed herein. It is intended that the present specification and examples be considered as exemplary only.

What is claimed is:

1. A method for forming a tracked self-mailer, the method comprising:
generating a print image comprising a shipping label, a color-postal-form, and a document, wherein the shipping label comprises a delivery address, a return address, and a tracking number;
in a single operation, printing the print image on a sheet of paper comprising a first face and an opposite second face, such that the shipping label and the color-postal-form are printed on the first face and the document is printed on at least a portion of the second face;
folding the sheet of paper, such that the first face is exposed for reading, to form an envelope comprising three non-closed edges, an address panel, and a non-address panel, wherein the shipping label is wholly displayed in the address panel; and
sealing the three non-closed edges, such that the second face of the sheet of paper is unreadable without manipulating the seal.

2. The method of claim 1, wherein the printing further comprises printing a postage indicia on the first face.

3. The method of claim 1, wherein the printing comprises printing the color-postal-form partially on the address panel and partially on the non-address panel and the folding comprises aligning the partially printed color-postal-form on the address panel with the partially printed color-postal-form on the non-address panel.

4. The method of claim 1, wherein the color-postal-form comprises a CERTIFIED MAIL indicia in a green color.

5. The method of claim 1, wherein the printing further comprises printing a taggant on the address panel.

6. The method of claim 1, wherein the color-postal-form further comprises a return receipt and a CERTIFIED MAIL indicia in a green color, and the method further comprises weakening the sheet of paper along a periphery of the return receipt to facilitate and localize tearing of the return receipt from the sheet of paper.

7. The method of claim 6, wherein
the sheet of paper comprises a 8.5 inch by 14 inch paper,
the printing further comprises printing a postage indicia on the first face, and printing the color-postal-form partially on the address panel and partially on the non-address panel,
the folding comprises three parallel latitudinal folds, such that the non-address panel comprises an end of the sheet of paper, and
the sealing comprises applying at least one tab to each of the three non-closed edges.

8. The method of claim 6, wherein
the sheet of paper comprises a 11 inch by 17 inch paper,
the printing further comprises printing a postage indicia on the first face, and printing the color-postal-form partially on the address panel and partially on the non-address panel,
the folding comprises one latitudinal fold, and
the sealing comprises applying at least one tab to each of the three non-closed edges.

9. The method of claim 1, wherein the folding comprises making two or more folds, and the printing comprises printing the document on at least a portion of the first face.

10. The method of claim 1, further comprising
providing at least one processor interfacing a network;
receiving through the network an electronic version of the document;
receiving through the network one or more options for printing the document;
receiving through the network the delivery address; and
receiving through the network the return address.

11. The method of claim 10, wherein the one or more printing options comprises one or more finishing instructions, selected from one or more of folding, binding, stapling, tabbing, adhesive, single-sided printing, double-sided printing, full color printing, limited color printing, and black & white printing.

12. The method of claim 10, wherein the one or more printing options comprises a service class option selected from one or more of First Class mail and PRIORITY MAIL used with one or more of CERTIFIED MAIL, CERTIFIED MAIL with return receipt, CERTIFIED MAIL with electronic return receipt, or CERTIFIED MAIL with Restricted Delivery.

13. The method of claim 10, further comprising merging the document with the delivery address.

14. The method of claim 10, further comprising:
receiving through the network, information for customizing the document; and
merging the document with the information to create a customized document.

15. The method of claim 10, further comprising standardizing the delivery address to conform with a predetermined address format.

16. The method of claim 10, further comprising:
verifying the delivery address with a database to determine if an addressee corresponding to the delivery address has changed his physical delivery address; and
updating the delivery address when it is determined that the physical delivery address has changed.

17. The method of claim 10, further comprising:
estimating a fee for printing the document;
estimating a fee for delivering the printed document to the delivery address; and
accepting payment through the network based on the estimated fee for printing the document and the estimated fee for delivering the printed document.

18. The method of claim 1, wherein the print image is printed on the first face and the second face simultaneously.

19. A method for forming a tracked self-mailer, the method comprising:
pre-printing a color postal form on a sheet of paper;
generating a print image comprising a shipping label, and a document, wherein the shipping label comprises a delivery address, a return address, and a tracking number;
printing the print image on the sheet of paper comprising a first face and an opposite second face, such that the shipping label and the color-postal-form are printed on the first face and the document is printed on at least a portion of the second face;
folding the sheet of paper, such that the first face is readable and forms an envelope comprising three non-closed edges, an address panel, and a non-address panel, wherein the shipping label is wholly displayed in the address panel;
sealing the three non-closed edges, such that the second face of the sheet of paper is unreadable without manipulating the seal; and
electronically tracking a delivery of the envelope based on the tracking number by checking a web-site.

20. The method of claim 19, wherein the printing comprises printing the color-postal-form partially on the address panel and partially on the non-address panel and the folding comprises aligning the partially printed color-postal-form on the address panel with the partially printed color-postal-form on the non-address panel.

21. The method of claim 19, wherein the color-postal-form further comprises a return receipt and a CERTIFIED MAIL indicia in a green color, and the method further comprises weakening the sheet of paper along a periphery of the return receipt to facilitate and localize tearing of the return receipt from the sheet of paper.

22. A system for forming a tracked self-mailer using at least processor interfacing a network, the system comprising:
a user interface for receiving through the network, a document, a delivery address, a return address, and one or more options for printing;
a tracking number generator configured for generating a tracking number;
a print image generator configured for generating a print image comprising a shipping label, a color-postal-form, and the document, wherein the shipping label comprises the delivery address, the return address, and the tracking number;
a printing device adapted to print the print image on a sheet of paper comprising a first face and an opposite second face, such that the shipping label and the color-postal-form are printed on the first face and the document is printed on at least a portion of the second face, wherein the print image is printed on the first face and the second face, substantially contemporaneously;
a folding device that folds the sheet of paper, such that the first face is readable and forms an envelope comprising three non-closed edges, an address panel, and a non-address panel, wherein the shipping label is wholly displayed in the address panel; and
a sealing device that seals the three non-closed edges, such that the second face of the sheet of paper is unreadable without manipulating the seal.

23. The system of claim 22, wherein the printing device prints the color-postal-form partially on the address panel and partially on the non-address panel and the folding device aligns the partially printed color-postal-form on the address panel with the partially printed color-postal-form on the non-address panel.

24. The system of claim 22, wherein the color-postal-form further comprises a return receipt and a CERTIFIED MAIL indicia in a green color, and the system further comprises a perforating device capable of perforating the sheet of paper along a periphery of the return receipt, such that the return receipt is capable of being torn from the sheet of paper.

25. The system of claim 22, wherein
the sheet of paper comprises a 8.5 inch by 14 inch paper,
the printing device prints a postage indicia on the first face, and prints the color-postal-form partially on the address panel and partially on the nor-address panel,
the folding device is capable of performing three parallel latitudinal folds, such that the non-address panel comprises an end of the sheet of paper, and
the sealing device comprises applying at least one tab to each of the three non-closed edges.

26. A computer program product, comprising a computer readable medium having computer program code embodied in said medium, for delivery of a printed document using at least one processor interfacing a network, wherein the program code comprises:
code for generating a tracking number;
code for generating a print image comprising a shipping label, a color-postal-form, and a document, wherein the shipping label comprises a delivery address, a return address, and the tracking number; and
code for printing in a single operation the print image on a sheet of paper comprising a first face and an opposite second face, such that the shipping label and the color-postal-form are printed on the first face and the document is printed on at least a portion of the second face;
wherein the sheet of paper is folded, such that the first face is readable and forms an envelope comprising three non-closed edges, an address panel, and a non-address panel, wherein the shipping label is wholly displayed in the address panel, and the sheet of paper is sealed along the three non-closed edges, such that the second face of the sheet of paper is unreadable without manipulating the seal.

27. The computer program product of claim 26, further comprising code for receiving through the network, the document, the delivery address, the return address, and one or more options for printing;
